(19) United States
(12) Patent Application Publication
(10) Pub. No.: US 2026/0336994 A1
(43) Pub. Date: Oct. 29, 2026

(54) DYNAMIC HEADLIGHT SYSTEM AND METHOD

(71) Applicant: Toyota Material Handling, Inc., Columbus, IN (US)

(72) Inventors: Sumit Ojas Narang, Columbus, IN (US); Kevin Partridge, Columbus, IN (US); Pranay Junnuthula, Columbus, IN (US); Thomas Louis Stemnock, Columbus, IN (US)

(21) Appl. No.: 19/657,813

(22) Filed: Apr. 24, 2026

Related U.S. Application Data
(60) Provisional application No. 63/794,112, filed on Apr. 24, 2025.

(51) Int. Cl. B66F 9/075

(52) U.S. Cl. CPC B66F 9/07504; B66F 9/0759

(57) ABSTRACT

A material handling vehicle including a mast coupled to a body and slidably engaged with a set of forks, a hydraulic cylinder configured to raise and lower the set of forks along the mast, a height sensor configured to determine a height of a portion of the set of forks with respect to a threshold height, a light assembly coupled to the body, the light assembly including an upper light portion and a lower light portion, and a controller coupled to the height sensor and the light assembly. The controller is configured to send a first signal to the light assembly to illuminate the upper light portion and the lower light portion at varying intensities based on the height of the portion of the set of forks.

### CROSS REFERENCE TO RELATED APPLICATION

This application claims priority to U.S. Provisional Patent Application No. 63/794,112 filed Apr. 24, 2025, the entire disclosure of which is incorporated by reference herein.

### BRIEF SUMMARY

This disclosure generally relates to material handling vehicles. More specifically, this disclosure relates to material handling vehicles equipped with a dynamic headlight system and associated methods for operating and controlling the dynamic headlight system.

### BACKGROUND

Material handling vehicles, such as forklifts, are typically equipped with static headlights that project light in a single direction regardless of the height and/or position of a vehicle load-carrying component (e.g., the carriage and/or forks). When the load-carrying component is raised during material loading or unloading, the static headlights may fail to adequately illuminate the working area, especially in dimly lit environments, such as warehouses. The static headlight configuration may reduce visibility and thus operational efficiency of the material handling vehicles.

Additionally, static headlights may cause glare to pedestrians or others in the vicinity of the material handling vehicle, which may create potential safety hazards. Accordingly, it would be useful to incorporate dynamic lighting systems that automatically adjust headlight intensity and/or light direction based on a height and/or position of a load-carrying component or other operational parameters of the material handling vehicles. A dynamic headlight system would enhance visibility for vehicle operators, reduce glare to pedestrians, and improve safety and efficiency in material handling operations.

### SUMMARY

In some embodiments, a material handling vehicle includes a mast coupled to a body and slidably engaged with a set of forks, a hydraulic cylinder configured to raise and lower the set of forks along the mast, a height sensor configured to determine a height of a portion of the set of forks with respect to a threshold height, a light assembly coupled to the body, the light assembly including an upper light portion and a lower light portion, and a controller coupled to the height sensor and the light assembly. The controller is configured to send a first signal to the light assembly to illuminate the upper light portion at a first intensity and the lower light portion at a second intensity when the height of the portion of the set of forks is above the threshold height, and send a second signal to the light assembly to illuminate the lower light portion at the first intensity and not illuminate the upper light portion when the height of the portion of the set of forks is below the threshold height.

In some embodiments, the height sensor is one of a height switch, a linear position sensor configured to detect an extension length of the hydraulic cylinder, or a pressure sensor configured to detect a pressure in one or more internal portions of the hydraulic cylinder.

In some embodiments, the portion of the set of forks is one or more of a bottom surface of the set of forks, an upper surface of the set of forks, a support bar extending between the set of forks, a high point of the set of forks, or a low point of the set of forks.

In some embodiments, the first intensity is a 100% illumination intensity and the second intensity is a 50% illumination intensity.

In some embodiments, the upper light portion includes a first plurality of light sources and the lower light portion includes a second plurality of light sources.

In some embodiments, the light assembly further includes at least one side light portion, and the controller is configured to send a third signal to the light assembly to illuminate the at least one side light portion when one of: the set of forks is moving in a first direction, the set of forks is moving in a second direction, the set of forks is above the threshold height, the set of forks is below the threshold height, an operator presence system is active, the operator presence system is not active, a turn signal is activated in a first direction, a turn signal is activated in a second direction, or a pedestrian is detected by a camera of the material handling vehicle.

In some embodiments, in response to the third signal, the at least one side light portion is illuminated in one or more of an animation pattern, a color, or a third light intensity.

In some embodiments, the operator presence system includes one or more of a seat switch or a seatbelt interlock, and the operator presence system is active when the seat switch is not actuated or when the seatbelt interlock is active.

In some embodiments, the seatbelt interlock is active when a seatbelt is not buckled.

In some embodiments, the vehicle further includes a camera configured to detect a presence of a pedestrian, wherein the lower light portion is illuminated at the second intensity when the camera detects the presence of a pedestrian, regardless of the height of the portion of the set of forks.

In some embodiments, the vehicle further includes a camera configured to detect a presence of a pedestrian, wherein one or both of the lower light portion or the upper light portion are illuminated in an animation pattern and the vehicle is decelerated when the camera detects the presence of a pedestrian.

In some embodiments, a material handling vehicle includes a mast coupled to a body and slidably engaged with a carriage, the carriage being raised and lowered along the mast by a hydraulic cylinder, a height sensor configured to determine a height of at least one portion of the carriage with respect to a threshold height on the mast, at least one light assembly coupled to the body, the at least one light assembly defining an illumination output, and a controller coupled to the height sensor and the at least one light assembly, wherein the controller dynamically adjusts the illumination output of the at least one light assembly in response to the height of the at least one portion of the carriage determined by the height sensor.

In some embodiments, the controller sends a first signal to the at least one light assembly to provide a first illumination output when the height of the at least one portion of the carriage is above the threshold height and sends a second signal to the at least one light assembly to provide a second illumination output when the height of the at least one portion of the carriage is below the threshold height.

In some embodiments, the at least one light assembly includes an upper light portion having one or more light sources and a lower light portion having one or more light sources.

In some embodiments, the first illumination output includes illuminating the upper light portion at a first intensity and the lower light portion at a second intensity, and the second illumination output includes illuminating the lower light portion at the first intensity and not illuminating the upper light portion.

In some embodiments, the first intensity is a 100% illumination intensity and the second intensity is a 50% illumination intensity.

In some embodiments, the height sensor is one of a height switch, a linear position sensor configured to detect an extension length of the hydraulic cylinder, or a pressure sensor configured to detect a pressure in one or more internal portions of the hydraulic cylinder.

In some embodiments, a material handling vehicle includes a mast coupled to a body and slidably engaged with a set of forks, a hydraulic cylinder configured to raise and lower the set of forks along the mast, a height sensor configured to determine a height of a portion of the set of forks with respect to a threshold height on the mast, a light assembly coupled to the body, the light assembly including an upper light portion, a lower light portion, and a side light portion, an operator presence system configured to detect a presence of an operator, a pedestrian detection system configured to detect a presence of a pedestrian, and a controller coupled to the height sensor, the light assembly, the operator presence system, and the pedestrian detection system, wherein the controller is configured to: send a first signal to the light assembly to illuminate the upper light portion at a first intensity and the lower light portion at a second intensity when the height of the portion of the set of forks is above the threshold height, send a second signal to the light assembly to illuminate the lower light portion at the first intensity and not illuminate the upper light portion when the height of the portion of the set of forks is below the threshold height, and send a third signal to the light assembly to illuminate the side light portion when one or more of the operator presence system is active or the presence of a pedestrian is detected.

In some embodiments, the operator presence system includes one or more of a seat switch or a seatbelt interlock, and the operator presence system is active when the seat switch is not actuated or when the seatbelt interlock is active.

In some embodiments, the seatbelt interlock is active when a seatbelt is not buckled.

### BRIEF DESCRIPTION OF THE DRAWINGS

FIG. 1 is a front isometric view of a material handling vehicle according to an example;

FIG. 2A illustrates a first configuration of a light assembly of the material handling vehicle of FIG. 1;

FIG. 2B illustrates a second configuration of the light assembly of FIG. 2A;

FIG. 2C illustrates a third configuration of the light assembly of FIG. 2A;

FIG. 3 is a block diagram of various components of the material handling vehicle of FIG. 1;

FIG. 4 illustrates an example display of a height and/or position selector for a load-carrying component of the material handling vehicle of FIG. 1;

FIGS. 5A and 5B are tables with voltage values corresponding to controller pin connections when a load-carrying component of the material handling vehicle of FIG. 1 is in a low height position and a high height position; and

FIG. 6 is a flow diagram depicting a method for dynamically changing an illumination output of a light assembly of the material handling vehicle of FIG. 1.

### DETAILED DESCRIPTION

The following discussion is presented to enable a person skilled in the art to make and use examples of the disclosure. Various modifications to the illustrated examples will be readily apparent to those skilled in the art, and the generic principles herein may be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize that the examples provided herein have many useful alternatives and fall within the scope of examples of the disclosure.

Before any examples of the disclosure are explained in detail, it is to be understood that the disclosure is not limited in its application to the details of construction and the arrangement of components set forth in the following description or illustrated in the attached drawings. The disclosure is capable of other examples and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed ther-after and equivalents thereof, as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

A dynamic light adjustment system for a material handling vehicle is provided. The dynamic light adjustment system may automatically adjust headlight illumination output, such as light intensity, direction, color, or animation pattern based on the height and/or position of a load-carrying component of the material handling vehicle. More particularly, a light assembly having one or more light sources may be dynamically adjusted based on signals received from a sensor or another component of the material handling vehicle that indicates a height and/or position of the load-carrying component. In some examples, the signals may be received from a height switch or sensor that monitors and detects the height of the load-carrying component. In some examples, the signals may be received from a reel sensor that monitors and detects the position and/or length of a hydraulic cable or hose being extended or retracted. In some examples, the signals may be provided in a form of computer area network (“CAN”) signals transmitted from a hydraulic system, such as a hydraulic cylinder of the material handling vehicle. Dynamic control of the lighting assembly may be achieved using various configurations. The dynamic lighting adjustment systems disclosed herein advantageously enhance visibility for vehicle operators, reduce glare to pedestrians, and improve safety and efficiency in material handling operations. Other advantages and benefits are highlighted in the following description in reference to the accompanying figures.

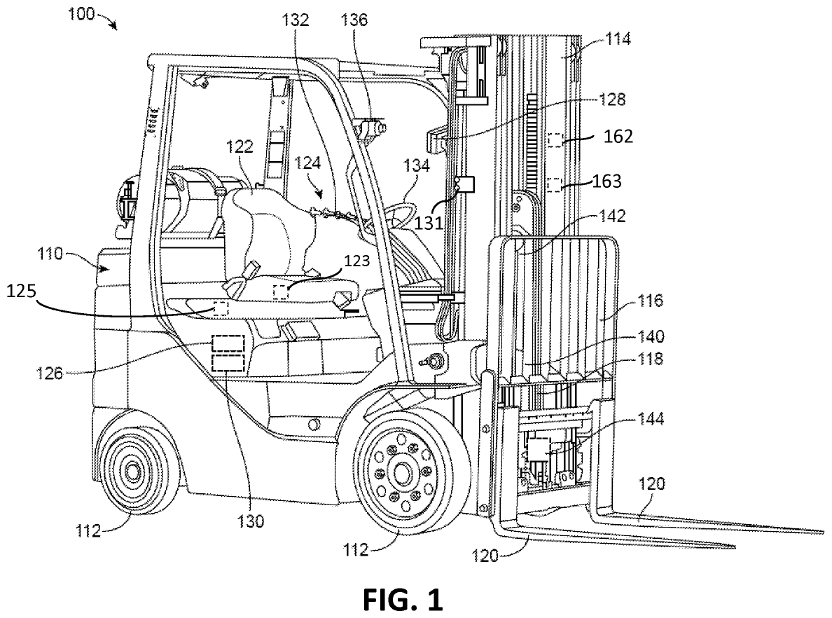

FIG. 1 illustrates a material handling vehicle 100 according to one example. The material handling vehicle 100 includes a body 110, a set of wheels 112, a mast 114, a carriage 116, and at least one hydraulic cylinder 118. The set of wheels 112 is rotatably engaged with the body 110 to move the material handling vehicle 100 about a work area (e.g., warehouse, factory, lumber yard, etc.). The mast 114 is pivotably attached to the body 110 and slidably engaged with the carriage 116. In some examples, slidably engaged means that the mast 114 slides and/or moves relative to the carriage 116 while still maintaining contact or connection. The hydraulic cylinder 118 is supported by the mast 114 and engaged with the carriage 116 to raise and lower the carriage 116 along the mast 114. In some examples, the hydraulic cylinder(s) 118 may operate between two sections of the mast 114 to extend the mast 114 along a height or length.

In the illustrated example, the carriage 116 is equipped with a set of forks 120 to engage palletized or other forms of loads. The carriage 116 with the set of forks 120 is just one example of a load-carrying component that may be used with the material handling vehicle 100. For example, the load-carrying component may be provided with any configuration to engage various loads (e.g., a paper roll clamp, a loaded container handler, the carriage 116 with a different load-carrying implement, etc.). It should also be understood that the hydraulic cylinder 118 may be implemented as multiple hydraulic cylinders, including a primary hydraulic cylinder for partial free lift and one or more secondary hydraulic cylinders for full free lift. In some forms, the hydraulic cylinder 118 also includes one or more tilt cylinders for tilting the mast 114 in the fore and aft directions.

The material handling vehicle 100 further includes an operator seat 122, an operator seat switch 123, hand controls 124, a seatbelt interlock 125, a controller 126, a display 128, a telematics system 130, and a camera 131. The operator seat switch 123 and the seatbelt interlock 125 can be part of an operator presence system for the material handling vehicle 100. In some forms, the operator presence system is activated (e.g., detects a concern related to operator presence) when the operator seat switch 123 is not actuated but the motor or engine of the material handling vehicle 100 is running. In some forms, the operator presence system is activated when the seatbelt interlock 125 is active (e.g., detects a concern related to seatbelt operation). Further, the seatbelt interlock 125 is active when a seatbelt of the material handling vehicle 100 is not buckled. In the example of FIG. 1, the hand controls 124 include a set of levers 132 and a steering wheel 134. In some examples, the hand controls 124 may include other or additional control devices, such as a joystick, a knob, a handwheel, a button, a switch, a pedal, etc., alternatively or in addition to the illustrated set of levers 132 and steering wheel 134.

The material handling vehicle 100 also includes at least one light assembly 136 moveably mounted to the body 110 and/or the mast 114. In some forms, the at least one light assembly is mounted to the body 110 via an adjustable, universal bracket such that the at least one light assembly 136 can be retrofitted onto a variety of different material handling vehicles at varying heights to optimize the position of the at least one light assembly 136 with respect to the mast 114, the carriage 116, the set of forks 120, the operator seat 122, etc. In some examples, the material handling vehicle 100 includes two or more light assemblies 136 arranged on opposing sides of the body 110 and/or the mast 114. The at least one light assembly 136 is generally directed forward in the direction of the load-carrying component (e.g., the carriage 116 with the set of forks 120).

The operator seat switch 123, the hand controls 124, the seatbelt interlock 125, the display 128, the telematics system 130, the camera 131, and the at least one light assembly 136 may be electrically and/or communicatively connected to the controller 126. The controller 126 processes and communicates operator inputs from the hand controls 124 to the functional equipment of the material handling vehicle 100 (e.g., the set of wheels 112, the mast 114, the carriage 116, the hydraulic cylinder 118, the at least one light assembly 136, etc.). The controller 126 is also designed to execute one or more commands from the telematics system 130. The display 128 shows information such as operating parameters, equipment statuses, maintenance schedules, preventative maintenance recommendations, location, operator checklists, instructions, warnings, light assembly settings, etc., to the operator.

Additionally, the hydraulic cylinder 118 may be implemented with a barrel 140, a piston 142, and a sensor 144. The barrel 140 slidably receives the piston 142 and supports the sensor 144. More particularly, the sensor 144 is at least partially disposed within the barrel 140. When hydraulic oil fills and is pressurized within the barrel 140, the piston 142 extends out of the barrel 140. When the hydraulic oil is depressurized and drains from the barrel 140, the piston 142 retracts into the barrel 140. Thus, the hydraulic cylinder 118 actuates the carriage 116 upwardly and downwardly along the mast 114 when the barrel 140 is pressurized and depressurized with hydraulic oil. The sensor 144 measures operational parameters of the hydraulic cylinder 118, such as displacement of the piston 142 relative to the barrel 140 and a stroke count associated with the retraction and extension of the piston 142. Further, the sensor 144 measures oil pressure, oil temperature, and particulate concentration of the hydraulic oil within the barrel 140. The sensor 144 may be communicatively connected to the controller 126 and in some forms, may be provided as a sensor module including multiple sensors or sensing devices.

In some instances, in response to data from the sensor 144 and/or the telematics system 130, the controller 126 restricts lift heights of the carriage 116 and/or moves the carriage 116 to one or more predetermined heights along the mast 114 (e.g., to align with palletized racks, a default travel and/or float height, etc.). In some aspects, the lift height of the carriage 116 may be restricted based on a specific location or zone (e.g., within a warehouse, loading dock, factory, pedestrian zone, charging, etc.). In some examples, the controller 126 restricts a lift height of the carriage 116 and/or moves the carriage 116 to a predetermined height based on a location detected by one or more sensors of the material handling vehicle 100 (e.g., global positioning system (GPS), radio-frequency identification (RFID), accelerometer, gyroscope, internet of things (IoT), position sensor, etc.), a computer vision system, or a combination thereof.

In some instances, using data from the sensor 144 and/or the telematics system 130, the controller 126 restricts a speed, and/or a drive state (e.g., forward, reverse, turning, etc.) of the material handling vehicle 100. In a non-limiting example, the lift height of the carriage 116, a speed of the material handling vehicle 100, and/or a drive state of the material handling vehicle 100 is determined using geofencing. In some instances, predetermined lift heights, lift height ranges, lift height restrictions, and/or lift height thresholds are customizable via the hand controls 124, the display 128, the telematics system 130, the set of levers 132, the steering wheel 134, or a combination thereof. In some instances, the predetermined lift heights, lift height ranges, lift height restrictions, and/or lift height thresholds of the carriage 116 are additionally or alternatively customizable via a server, a computing or mobile device, a mobile device, and/or a network.

The at least one light assembly 136 may be dynamically adjusted in response to changes to various operational characteristics of the material handling vehicle 100. In some examples, an illumination output defined by the at least one light assembly 136, such as the light intensity and/or light direction, may be dynamically adjusted based on a height and/or position of the mast 114, the carriage 116, the set of forks 120, and/or another load-carrying component. The height and/or position may be determined using a height switch 162 (e.g., a height sensor) configured to monitor movement and detect changes to the mast 114, the carriage 116, the set of forks 120, and/or another load-carrying component. The illumination output of the at least one light assembly 136 may vary depending on the height and/or position and may be continuously dynamically adjusted in response to height and/or position changes. In some embodiments, the height switch 162 is provided in the form of one or more of a physical height switch, a reed switch, a hall effect sensor, a rotary encoder, a string pot, an LVDT, among others.

In some examples, the illumination output of the at least one light assembly 136 may be dynamically adjusted based on measurements taken by a reel sensor 163. The reel sensor 163 may detect the position and/or length of a hydraulic cable or hose being extended or retracted in response to movement of the mast 114 and/or a load-carrying component. The hydraulic cable or hose is generally coupled to the hydraulic cylinder 118 on a first end and to the mast 114 on a second end. In some examples, the illumination output of the at least one light assembly 136 may be dynamically adjusted in response to movement of the mast 114 and/or the load-carrying component to one or more predetermined heights. The one or more predetermined heights may be selected by an operator and executed by the controller 126 that carries out the height selection in conjunction with the hydraulic cylinder 118. The illumination output may be adjusted simultaneously or nearly simultaneously with movement of the mast 114 to the predetermined height(s).

In some examples, the illumination output of the at least one light assembly 136 may be dynamically adjusted based on computer area network (“CAN”) signals received from a hydraulic application of the material handling vehicle 100, such as the hydraulic cylinder 118. For example, CAN signals based on the extension or retraction of the hydraulic cylinder 118 may be transmitted directly to the at least one light assembly 136 to enable simultaneous or nearly simultaneous illumination output adjustment. In such examples or others, CAN signals may also be transmitted to the controller 126 that is communicatively connected to the at least one light assembly 136. The controller 126 may instruct the at least one light assembly 136 to adjust illumination output based on the CAN signals simultaneously or nearly simultaneously upon receipt of the CAN signals by the controller 126.

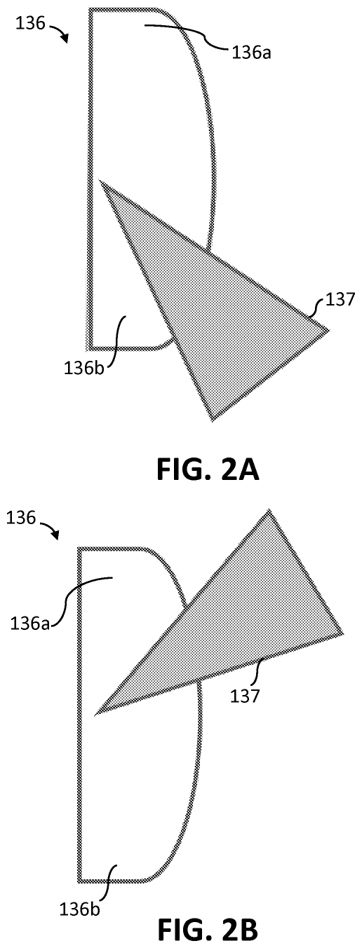

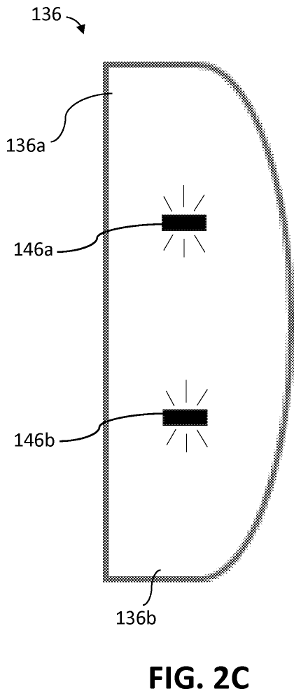

As shown in FIGS. 2A-2C, each light assembly 136 may include one or more light sources, such as light-emitting diodes (“LEDs”). In reference to FIGS. 2A and 2B, in some examples, the at least one light assembly 136 may include at least an upper light portion 136a and a lower light portion 136b generally oriented vertically. Both the upper light portion 136a and the lower light portion 136b may include one or more individual light sources. For example, the upper light portion 136a and the lower light portion 136b may each include between two and six individual light sources arranged in a row or a pattern. Preferably, the upper light portion 136a and the lower light portion 136b may each include three individual light sources. Other numbers of light sources greater than six are also contemplated by the present disclosure for the upper light portion 136a and the lower light portion 136b of the at least one light assembly 136. The upper light portion 136a and the lower light portion 136b may include different quantities of individual light sources in some examples.

As shown in FIG. 2C, in some examples, the at least one light assembly 136 may include at least a first side light portion 146a and a second side light portion 146b generally oriented horizontally. If arranged horizontally, the upper light portion 136a may act as the first side light portion, and the lower light portion 136b may act as the second side light portion. Both the first and second side light portions 146a, 146b may include one or more individual light sources, for example, between two and six individual light sources each or preferably three light sources each arranged in a row or a pattern. In some examples, the at least one light assembly 136 may operate in a voltage range of 8 to 90V for a material handling vehicle 100 having a minimum voltage range of 15 to 100V, and preferably 25 to 90V. In some examples, the at least one light assembly 136 may comprise a housing that contains one or more individual light sources. The housing may be made from a variety of materials including metals and polymers (e.g., polycarbonate), or other materials.

FIGS. 2A, 2B, and 2C illustrate, respectively, a first configuration, a second configuration, and a third configuration of a light assembly 136 of the material handling vehicle 100 of FIG. 1. Referring to FIG. 2A, in some examples, downward movement of the mast 114 or the load-carrying component may cause an upper light portion 136a to turn off or dim while a lower light portion 136b is turned on. The first lighting configuration may include where one or more individual light sources of the upper light portion 136a and the lower light portion 136b are affected by movement of the mast 114. Referring to FIG. 2B, in some examples, upward movement of the mast 114 or the load-carrying component may enable the upper light portion 136a to turn on while the lower light portion 136b is turned off or dimmed. The second lighting configuration may include one or more light sources of the upper light portion 136a being turned on and one or more light sources of the lower light portion 136b being turned off or dimmed. A light beam 137 from the upper light portion 136a and the lower light portion 136b is illustrated in the figures.

FIGS. 2A and 2B represent example first and second lighting configurations, respectively, of the light assembly 136 based on a height and/or a position of the mast 114 as detected by the height switch 162. For example, the first lighting configuration may be activated when the carriage 116, a portion thereof, the set of forks 120, or a portion thereof crosses below a threshold height as detected by the height switch 162. Alternatively, the second lighting configuration may be activated when the carriage 116, a portion thereof, the set of forks 120, or a portion thereof crosses above a threshold height as detected by the height switch 162. In some embodiments, the portion of the set of forks 120 may be one or more of a bottom surface of the set of forks 120, an upper surface of the set of forks 120, a support bar extending between the set of forks 120, a high point of the set of forks 120, or a low point of the set of forks 120. Similarly, in some embodiments, the portion of the carriage 116 may be one or more of a bottom surface of the carriage 116, an upper surface of the carriage 116, a support bar of the carriage 116, a high point of the carriage 116, or a low point of the carriage 116. However, other portions of the set of forks 120 or the carriage 116 are contemplated for contributing to the threshold height detection.

Additional lighting configurations are also contemplated by the present disclosure, including configurations where a combination of one or more light sources from both the upper light portion 136a and the lower light portion 136b are turned on, turned off, or dimmed. For example, it may be advantageous to turn on a combination of light sources if the mast 114 is moved to an intermediate position. The intermediate position may be between a raised position that generally causes the upper light portion 136a to turn on, and a lowered position that generally causes the lower light portion 136b to turn on. The intermediate position could enable the light beam 137 to be directed outward from the light assembly 136 in a straight or nearly straight direction.

In some examples, the upper and lower light portions 136a, 136b may be oriented vertically or horizontally with respect to the body 110 of the material handling vehicle 100. Additionally, some examples of the light assembly 136 may include a combined upper light portion 136a and a lower light portion 136b that may rotate in response to movement of the mast 114 to change the light direction. Rotation may occur along a vertical plane or a horizontal plane depending on how the light assembly 136 is mounted to the body 110. For example, the light assembly 136 may be rotated upward or downward to account for height and/or position changes with the mast 114.

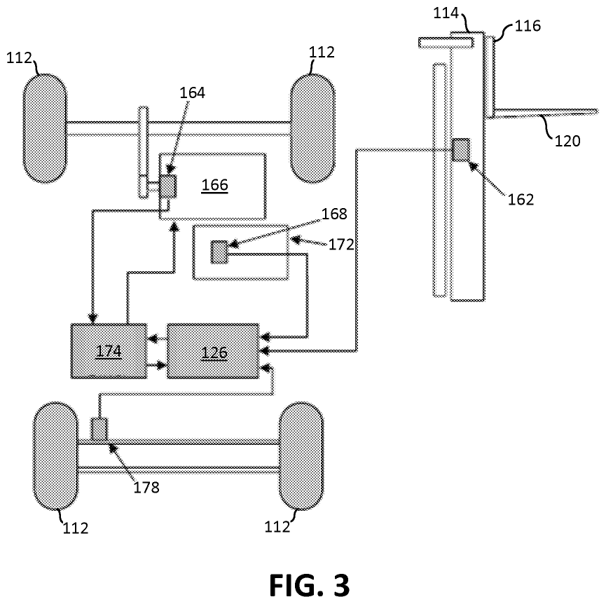

FIG. 3 illustrates a block diagram of various components associated with some examples of the material handling vehicle 100 of FIG. 1. The components include a height switch 162 operably or communicatively connected to at least one of the mast 114, the carriage 116, and/or the set of forks 120. The components further include a speed sensor 164 (e.g., a motor rotation speed sensor) for detecting the speed of the material handling vehicle 100, at least one drive motor 166 for driving the set of wheels 112, a load sensor 168 for detecting loads applied to the carriage 116 and/or the set of forks 120, an oil control valve 172 providing access to vehicle oil, a drive motor driver 174 communicatively connected to the at least one drive motor 166, the controller 126, and a wheel angle sensor 178 for detecting angles of the set of wheels 112 with respect to the body 110 of the material handling vehicle 100.

The height switch 162 may monitor and detect a height and/or position of the mast 114, the carriage 116, the set of forks 120, or a combination thereof. The height switch 162 may be communicatively or electrically connected to the at least one light assembly 136, for example, via a wired or wireless connection. The at least one light assembly 136 may dynamically adjust illumination output to account for height and/or position changes detected by the height switch 162. For example, the at least one light assembly 136 may adjust light intensity and/or light direction of one or more individual light sources in response to upward or downward movement of the mast 114 detected by the height switch 162. In response to upward movement, the light adjustment may include turning off or dimming one or more lower light sources, turning on one or more upper light sources, and/or animating one or more of the side light sources (such as the upper side light portion 146a). In response to downward movement, the light adjustment may include turning on one or more lower light sources, turning off or dimming one or more upper light sources, and/or animating one or more of the side light sources (such as the upper side light portion 146a) as discussed in more detail in connection with FIGS. 3A and 3B. In some forms, turning on a light source means providing approximately 100% illumination of the light source. In some forms, dimming a light source means providing less than approximately 100% illumination, such as 50% illumination. In some forms, animating a light source means illuminating the light source in an animation pattern, such as consistent on/off flashing, gradual changes to the light intensity, changing the color of the light source, etc.

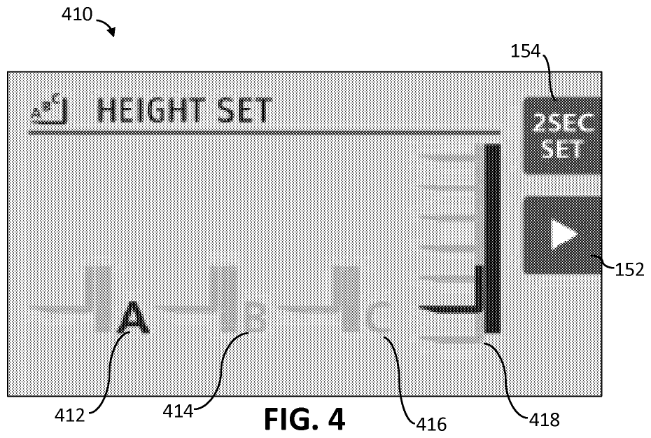

FIG. 4 illustrates an exemplary display of a height and/or position selector 410 for a load-carrying component of the material handling vehicle 100 of FIG. 1. The height and/or position selector 410 may include one or more predetermined heights and/or positions for the load-carrying component, such as the carriage 116 and/or the set of forks 120. The predetermined heights and/or positions may be commonly used levels in a warehouse or another work environment. In other aspects, the predetermined heights may be customized via a user interface, mobile application, remote server, or other user input. In some examples, the height and/or position selector 410 may include a first height/position selection 412 (e.g., a low height/position such as about 4 inches or less), a second height/position selection 414 (e.g., a central height/position such as about 24 inches), a third height/position selection 416 (e.g., a high height/position such as about 48 inches or more), and a plurality of other height/positions selections 418 (e.g., intermediate heights/positions). An operator may select the desired height/position on the display, may use a button 152 to instruct the height and/or position selector 410, or other user input mechanism to instruct the load-carrying component to move to the selected predetermined height. The mast 114 (or a controller communicatively connected to the mast) may move the load-carrying component to the selected height and/or position based on the selection.

The at least one light assembly 136 may be dynamically adjusted in response to the selection from the height and/or position selector 410. For example, a low height and/or position selection may enable the upper light portion 136a (and/or the upper side light portion 146a) to turn off or dim while the lower light portion 136b (and/or the lower side light portion 146b) is turned on. In another example, a high height and/or position selection may enable the upper light portion 136a (and/or the upper side light portion 146a) to turn on while the lower light portion 136b (and/or the lower side light portion 146b) is turned off or dimmed. Intermediate selected portions may enable one or more light sources of both the upper light portion 136a and the lower light portion 136b to turn on while other light sources are turned off or dimmed. Height and/or position selections may be measured using data received from the reel sensor 163 that monitors and detects extension and retraction of a hydraulic cable or hose arranged along the mast 114. In other examples, height and/or position selections may be measured using data received from the height switch 162. Combined data from the height switch 162 and the reel sensor 163 may also be used in some examples.

In use, the at least one light assembly 136 may be communicatively or electrically connected to the controller 126, for example via a wired or wireless connection. The height and/or position selector 410, which may include the reel sensor 163 and/or the height switch 162 for measuring the height/position changes, may also be communicatively or electrically connected to the controller 126, for example via wiring or a wireless connection. Accordingly, a setting change made or instructed to be made by the controller 126 may enable simultaneous or nearly simultaneous dynamic illumination output adjustment of the at least one light assembly 136 in response to a height/position selection. In some aspects, the height and/or position selector 410 and the at least one light assembly 136 are controlled via the controller 126, wherein the controller 126 may manage and/or control the operation of multiple components of the material handling vehicle 100.

In some examples, if no selection is made using the height and/or position selector 410, then the controller 126 may be configured to operate the at least one light assembly 136 using the low and high height process described previously for the height switch 162. Specifically, a low height of the mast 114 and/or the load-carrying component may enable one or more light sources of the upper light portion 136a (and/or the upper side light portion 146a) to turn off or dim, while one or more light sources of the lower light portion 136b (and/or the lower side light portion 146b) are turned on to illuminate the area in front of the load-carrying apparatus. The reverse configuration may occur for a high height of the mast 114 and/or the load-carrying component. The controller 126 may reactivate operation with the height and/or position selector 410 if a selection is subsequently made.

Further description of related examples is provided in commonly owned U.S. Provisional Patent Application No. 63/670,505, filed Jul. 12, 2024, and titled “AUTOMATIC FORK ADJUSTMENT SYSTEM AND METHOD,” the disclosure of which is hereby incorporated by reference in its entirety. Such examples may be used with the dynamically adjustable headlight systems and methods described herein to provide variable illumination output based on predetermined heights and/or positions of the mast 114 and/or the load-carrying component of the material handling vehicle 100.

In other examples, the at least one light assembly 136 may be dynamically adjusted in response to CAN signals received from a hydraulic application of the material handling vehicle 100, such as the hydraulic cylinder 118. CAN signals derived from an operational parameter of the hydraulic cylinder 118 may be associated with changes in the height and/or position of the mast 114 and/or the load-carrying component. These signals may then be used to dynamically adjust illumination output of the at least one light assembly 136. In one example, CAN signals that include data related to the extension or retraction of the hydraulic cylinder 118 may be transmitted directly to the at least one light assembly 136 to enable simultaneous or nearly simultaneous illumination output adjustment. CAN signals may be generated by the sensor 144 that is at least partially disposed within the barrel 140 of the hydraulic cylinder 118.

In such examples or others, CAN signals may also be transmitted to the controller 126 communicatively connected to the at least one light assembly 136. The controller 126 may instruct the at least one light assembly 136 to adjust illumination output based on the CAN signals simultaneously or nearly simultaneously upon receipt of the CAN signals. Dynamic adjustment may enable a gradual change in illumination output to represent a gradual change in operation of the hydraulic cylinder 118. In other examples, illumination output of the at least one light assembly 136 may change before the hydraulic cylinder 118 reaches its final updated operational position or state.

Further description of related examples is provided in commonly owned U.S. patent application Ser. No. 19/175,110, filed Apr. 10, 2025, and titled “MAST HYDRAULIC SENSING SYSTEM AND METHOD,” the disclosure of which is hereby incorporated by reference in its entirety. Such examples may be used with the dynamically adjustable headlight systems and methods described herein to provide variable illumination output based on operational parameters of a hydraulic application of the material handling vehicle 100, such as the hydraulic cylinder 118. Operational parameters for the hydraulic cylinder 118 may include displacement of the piston 142 relative to the barrel 140 and a stroke count associated with the retraction and extension of the piston 142.

In some examples, the mast 114 may have an adjustable speed when changing the height of the load-carrying component. For example, the mast 114 may move slower at higher heights but faster at lower heights. In some examples, the material handling vehicle 100 may have an adjustable turning speed depending on the height of the mast 114 and/or the load-carrying component. For example, the turning speed may be slower when the mast 114 is at higher heights but faster when the mast 114 is at lower heights. In some examples, the at least one light assembly 136 may be dynamically adjusted using a combination of height and/or position measurements from the height switch 162, a predetermined height using the height and/or position selector 410, a hydraulic cable or hose length measured by the reel sensor 163, and/or CAN signals received from the hydraulic cylinder 118.

In some examples, the at least one light assembly 136 may be dynamically adjusted in response to wheel angle(s) measured by the wheel angle sensor 178 and/or turn signal activation by an operator. For example, one or more light sources on a left side of the light assembly 136 may be turned on (in an animated pattern or color in some forms) when the material handling vehicle 100 turns left or the left turn signal is activated, while one or more light sources on a right side are turned off or dimmed. Conversely, one or more light sources on a right side of the light assembly 136 may be turned on (in an animated pattern or color in some forms) when the material handling vehicle 100 turns right, while one or more light sources on a left side are turned off or dimmed. One or more light sources on the left and right sides may be turned on when the material handling vehicle 100 drives forward or in reverse. Light is thus provided in the direction the material handling vehicle 100 is moving or intends to move.

In some examples, the at least one light assembly 136 may include a light sensor configured to detect light around the material handling vehicle 100 and to dynamically adjust the illumination output of the at least one light assembly 136 in response. For example, the light sensor could detect a decrease in external light when the material handling vehicle 100 transitions from an outside area to a warehouse. In response, the light sensor may increase or intensify the illumination output from the at least one light assembly 136 to provide increased light around the material handling vehicle 100, which provides further dynamic illumination output adjustment of the at least one light assembly of the material handling vehicle 100.

A similar mechanism may be used to turn off or dim one or more light sources of the light assembly 136 when a pedestrian is detected. For example, in some examples, the material handling vehicle 100 may include one or more cameras in communication with the light assembly 136 and/or the controller 126. The camera 131 may be arranged in the same direction as the illumination output of the light assembly 136. Upon detecting a pedestrian, the light assembly 136 may dynamically adjust its illumination output to reduce glare for the pedestrian while still providing adequate lighting for the operator of the material handling vehicle 100 to clearly see the path and any objects ahead. For example, the lower light portion 136b may be dimmed when a pedestrian is detected, but not when an object is detected. Similarly, when an object is detected, the lower light portion 136b may be brightened when an object is detected but not a pedestrian, to enhance visibility of an obstruction. In some forms, the material handling vehicle 100 may be automatically decelerated by various onboard systems when a pedestrian is detected, and in such instances, one or more of the upper light portion 136a, the lower light portion 136b, the upper side light portion 146a, and the lower side light portion 146b may be illuminated in one or more light intensities or in an animation pattern (flashing, blinking, colors) to signal a warning and also indicate that the material handling vehicle 100 is coming to a stop. Dynamically adjusting an illumination output may include turning off or dimming one or more light sources in the upper light portion 136a while turning on one or more light sources in the lower light portion 136b directed toward the driving path.

In some forms, an illumination output of the light assembly 136 may be dynamically adjusted based on outputs from the operator presence system, e.g., the operator seat switch 123 and the seatbelt interlock 125. For example, when the operator presence system is activated, as described above, one or both of the side light portions 146a, 146b, may be turned on, or illuminated in an animation pattern (blinking, flashing, etc.) or color to indicate that one or both of the operator is not in the operator seat 122 or the operator is not properly wearing the seatbelt during activation of the traction motors.

In some examples, dynamic adjustment of the at least one light assembly 136 may be overridden by the operator or through another mechanism to return the at least one light assembly 136 to static operation (e.g., the at least one light assembly 136 is either on or off and cannot be dynamically updated in response to operational characteristic changes). In some examples, dynamic adjustment may be overridden by the operator using the display 128, using a button or a switch of the material handling vehicle 100 such as the combination switch for actuating various vehicle lights (headlights, etc.), or using an external device such as a cloud server, a computing device, a mobile device, or another electronic device in communication with the material handling vehicle 100 (e.g., in communication with the controller 126 and/or the at least one light assembly 136). In the manual override configuration, the upper light portion 136a may be turned on, dimmed, or turned off, the lower light portion 136b may be turned on, dimmed, or turned off, or any combination thereof. Accordingly, the combination switch can provide numerous manually selected lighting configurations. Dynamic adjustment based on any of the examples described herein may be resumed using a similar process but in a reverse or opposite manner (e.g., overriding static operation to return to dynamic adjustment of illumination output).

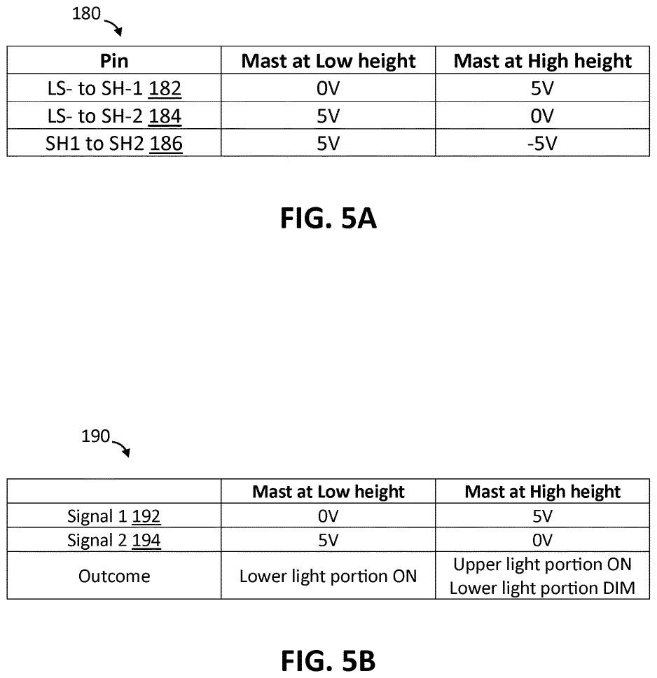

FIGS. 5A and 5B illustrate tables 180 and 190 with voltage values corresponding to controller 126 pin connections when the mast 114 or the load-carrying component of the material handling vehicle 100 of FIG. 1 is in a low height position and a high height position.

Referring first to the table 180 of FIG. 5A, a ground (“LS”) to a first switch height (“SH-1”) pin connection 182 may produce a zero voltage at a low height and a voltage of 5V at a high height. The pin connection 182 may represent the upper light portion 136a in some examples. An LS to a second switch height (“SH-2”) pin connection 184 may produce a voltage of 5V at a low height and a zero voltage at a high height. The pin connection 184 may represent the lower light portion 136b in some examples. A pin connection 186 between SH-1 and SH-2 may produce a voltage of 5V for the low height and -5V for the high height. The pin connection 186 may represent both the upper light portion 136a and the lower light portion 136b being turned on or illuminated in some examples.

Referring now to the table 190 of FIG. 5B, when the mast 114 or the load-carrying component is in a low height position, a first signal 192 of the light assembly 136 has a zero voltage and a second signal 194 of the light assembly 136 has a voltage of 5V. The low height configuration may trigger illumination of the lower light portion 136b, which, in some examples, may comprise three individual light sources arranged in a row or pattern. Alternatively, when the mast 114 or the load-carrying component is in a high height position, the first signal 192 has a voltage of 5V and the second signal 194 has a zero voltage. The high height position may trigger illumination of the upper light portion 136a, which, in some examples, may also comprise three individual light sources arranged in a row or pattern. Additionally, the lower light portion 136b may be dimmed in this configuration rather than completely turned off. In some examples, the first and second signals 192, 194 may have a zero voltage to turn the upper light portion 136a and the lower light portion 136b off. In some examples, the first and second signals 192, 194 may have a voltage of 5V to turn the upper light portion 136a and the lower light portion 136b on.

In some forms, a similar voltage activation scheme can apply to additional pins where a 6-pin connector is implemented. For example, additional pins may have a voltage of 5V when an activating function for the side light portions 146a, 146b occurs as described herein. In response, the side light portions 146a, 146b may be illuminated or not illuminated in response as described above. Similarly, additional pins may have a voltage of 5V when an activating function related to the operator seat switch 123 or the seatbelt interlock 125 occurs as described herein. In response, any of the lights of the light assembly 136 may be illuminated or not illuminated in response as described above.

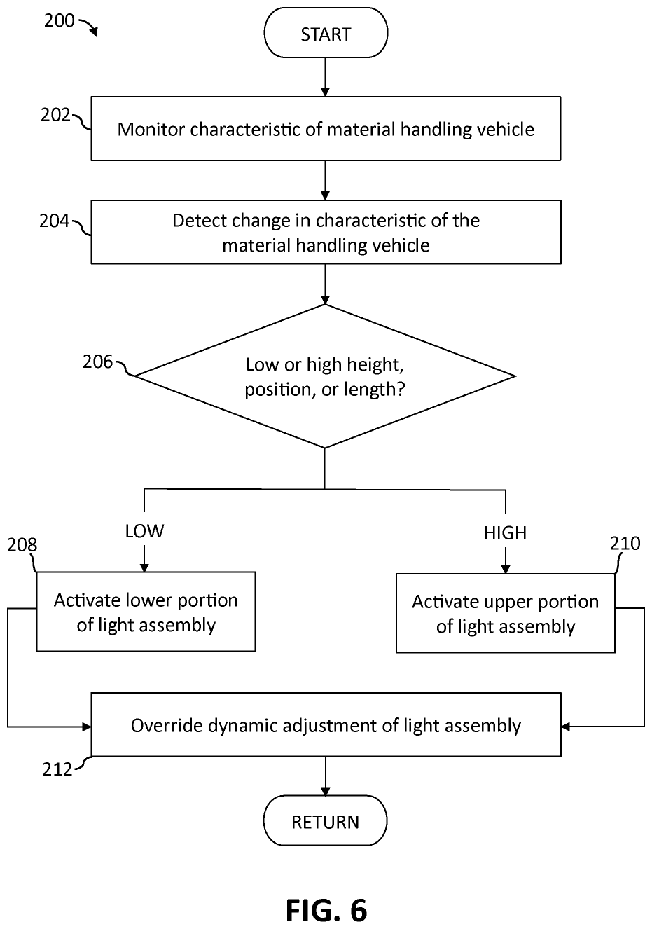

FIG. 6 illustrates a flow diagram depicting a method 200 for dynamically changing illumination output of a light assembly 136 of the material handling vehicle 100 of FIG. 1. Method 200 may be used with other material handling vehicles in addition to material handling vehicle 100 (e.g., pallet jacks, conveyors, lifts, hoppers, stackers, dump trucks, etc.).

At step 202, an operational characteristic of the material handling vehicle 100 may be monitored. In some examples, the operational characteristic may be the height and/or position of the mast 114 or a load-carrying component such as the carriage 116 and/or the set of forks 120. In some examples, the operational characteristic may be the position and/or length of a hydraulic cable or hose being extended or retracted. In some examples, the operational characteristic may be a predetermined height and/or position of the mast 114 or the load-carrying component selected by an operator using the height and/or position selector 410. In some examples, the operational characteristic may be CAN signals transmitted that indicate operational parameters of the hydraulic cylinder 118, such as cylinder extension or retraction. The operational characteristic may be monitored using one or more of the height switch 162, the reel sensor 163, the controller 126, the operator seat switch 123, the seatbelt interlock 125, the camera 131, the sensor 144 of the hydraulic cylinder 118, or another electronic device of the material handling vehicle 100.

At step 204, a change in the operational characteristic of the material handling vehicle 100 may be detected. Similar to monitoring, the change may be detected using an electronic device of the material handling vehicle 100, such as the height switch 162, the reel sensor 163, the controller 126, the operator seat switch 123, the seatbelt interlock 125, the camera 131, or the sensor 144 of the hydraulic cylinder 118, for example.

At step 206, a determination may be made of whether the operational characteristic change represents a low or high height, position, or length associated with the material handling vehicle 100. For example, if the operational characteristic is a height of the mast 114 or the load-carrying component, then the determination may be whether the height has changed from a low height to a high height, or vice versa. In another example, if the operational characteristic is a length of the hydraulic cable or hose from the reel sensor 163, then the determination may be whether the length has changed from an extended position to a retracted position, or vice versa. In another example, if the operational characteristic is CAN signals from the hydraulic cylinder 118, then the determination may be whether the length or another operational parameter of the hydraulic cylinder 118 has changed to indicate extension or retraction of the load-carrying component along the mast 114. Similar determinations may be made for other operational characteristics associated with the material handling vehicle 100.

If the determination is that the operational characteristic change represents a low height, position, or length, then at step 208 the illumination output defined by the at least one light assembly 136 of the material handling vehicle 100 may be dynamically adjusted to turn on the lower light portion 136b and turn off or dim the upper light portion 136a. Conversely, if the determination is that the operational characteristic change represents a high height, position, or length, then at step 210 the illumination output of the at least one light assembly 136 may be dynamically adjusted to turn on the upper light portion 136a and turn off or dim the lower light portion 136b. As described previously, the at least one light assembly 136 may be dynamically adjusted through direct coupling with the electronic device that provides the operational characteristic monitoring and detecting, or through direct coupling with the controller 126 which itself is directly coupled to the electronic device.

At step 212, dynamic adjustment of the at least one light assembly 136 may be overridden by the operator or through another mechanism to return the at least one light assembly 136 to static operation (e.g., the at least one light assembly 136 is either on or off and cannot be dynamically updated in response to operational characteristic changes). In some examples, dynamic adjustment may be overridden by the operator using the display 128, using a button or a switch of the material handling vehicle 100, or using an external device such as a cloud server, a computing device, a mobile device, or another electronic device in communication with the material handling vehicle 100 (e.g., in communication with the controller 126 and/or the at least one light assembly 136). Dynamic adjustment may resume using a similar process but in a reverse or opposite manner. In at least this way, dynamic adjustment provides control and customization for the operator of the material handling vehicle 100 and for others in communication therewith (e.g., via a remote server or similar).

Other operational characteristics of the material handling vehicle 100, including speed, wheel angle, driving direction, material load, the status of the operator presence system, the status of pedestrian detection, etc., may also be monitored, detected, and used to enable a dynamic adjustment of the at least one light assembly 136 using method 200. Changes in such operational characteristics may be recorded using sensors or other electronic components or devices of the material handling vehicle 100.

In other examples, other configurations are possible. For example, those of skill in the art will recognize, according to the principles and concepts disclosed herein, that various combinations, sub-combinations, and substitutions of the components discussed above may provide appropriate cooling for a variety of different configurations of motors, pumps, electronic assemblies, and so on, under a variety of operating conditions.

The previous description of the disclosed examples is provided to enable any person skilled in the art to make or use the disclosure. Various modifications to these examples will be readily apparent to those skilled in the art, and the generic principles defined herein may be applied to other examples without departing from the spirit or scope of the disclosure. Thus, the disclosure is not intended to be limited to the examples shown herein but is to be accorded the widest scope consistent with the principles and novel features disclosed herein.

What is claimed is:

1. A material handling vehicle, comprising:
a mast coupled to a body and slidably engaged with a set of forks, a hydraulic cylinder of the material handling vehicle being configured to raise and lower the set of forks along the mast;
a height sensor configured to determine a height of a portion of the set of forks with respect to a threshold height;
a light assembly coupled to the body, the light assembly including an upper light portion and a lower light portion; and
a controller coupled to the height sensor and the light assembly,
wherein the controller is configured to:
send a first signal to the light assembly to illuminate the upper light portion at a first intensity and the lower light portion at a second intensity when the height of the portion of the set of forks is above the threshold height, and
send a second signal to the light assembly to illuminate the lower light portion at the first intensity and not illuminate the upper light portion when the height of the portion of the set of forks is below the threshold height.

2. The material handling vehicle of claim 1, wherein the height sensor is one of a height switch, a linear position sensor configured to detect an extension length of the hydraulic cylinder, or a pressure sensor configured to detect a pressure in one or more internal portions of the hydraulic cylinder.

3. The material handling vehicle of claim 1, wherein the portion of the set of forks is one or more of a bottom surface of the set of forks, an upper surface of the set of forks, a support bar extending between the set of forks, a high point of the set of forks, or a low point of the set of forks.

4. The material handling vehicle of claim 1, wherein the first intensity is a 100% illumination intensity and the second intensity is a 50% illumination intensity.

5. The material handling vehicle of claim 1, wherein the upper light portion includes a first plurality of light sources and the lower light portion includes a second plurality of light sources.

6. The material handling vehicle of claim 1, wherein the light assembly further comprises at least one side light portion, and the controller is configured to send a third signal to the light assembly to illuminate the at least one side light portion when one of: the set of forks is moving in a first direction, the set of forks is moving in a second direction, the set of forks is above the threshold height, the set of forks is below the threshold height, an operator presence system is active, the operator presence system is not active, a turn signal is activated in a first direction, a turn signal is activated in a second direction, or a pedestrian is detected by a camera of the material handling vehicle.

7. The material handling vehicle of claim 6, wherein in response to the third signal, the at least one side light portion is one of illuminated in one or more of an animation pattern, a color, or a third light intensity.

8. The material handling vehicle of claim 6, wherein the operator presence system includes one or more of a seat switch or a seatbelt interlock, and the operator presence system is active when one of the seat switch is not actuated or when the seatbelt interlock is active.

9. The material handling vehicle of claim 8, wherein the seatbelt interlock is active when a seatbelt of the material handling vehicle is not buckled.

10. The material handling vehicle of claim 1, further comprising a camera configured to detect a presence of a pedestrian, wherein the lower light portion is illuminated at the second intensity when the camera detects the presence of a pedestrian, regardless of the height of the portion of the set of forks.

11. The material handling vehicle of claim 1, further comprising a camera configured to detect a presence of a pedestrian, wherein one or both of the lower light portion or the upper light portion are illuminated in an animation pattern and the material handling vehicle is decelerated when the camera detects the presence of a pedestrian.

12. A material handling vehicle, comprising:
a mast coupled to a body and slidably engaged with a carriage, the carriage being raised and lowered along the mast by a hydraulic cylinder;
a height sensor configured to determine a height of at least one portion of the carriage with respect to a threshold height on the mast;
at least one light assembly coupled to the body, the at least one light assembly defining an illumination output; and
a controller coupled to the height sensor and the at least one light assembly,
wherein the controller dynamically adjusts the illumination output of the at least one light assembly in response to the height of the at least one portion of the carriage determined by the height sensor.

13. The material handling vehicle of claim 12, wherein the controller sends a first signal to the at least one light assembly to provide a first illumination output when the height of the at least one portion of the carriage is above the threshold height and sends a second signal to the at least one light assembly to provide a second illumination output when the height of the at least one portion of the carriage is below the threshold height.

14. The material handling vehicle of claim 13, wherein the at least one light assembly includes an upper light portion having one or more light sources and a lower light portion having one or more light sources.

15. The material handling vehicle of claim 14, wherein the first illumination output includes illuminating the upper light portion at a first intensity and the lower light portion at a second intensity, and the second illumination output includes illuminating the lower light portion at the first intensity and not illuminating the upper light portion.

16. The material handling vehicle of claim 15, wherein the first intensity is a 100% illumination intensity and the second intensity is a 50% illumination intensity.

17. The material handling vehicle of claim 12, wherein the height sensor is one of a height switch, a linear position sensor configured to detect an extension length of the hydraulic cylinder, or a pressure sensor configured to detect a pressure in one or more internal portions of the hydraulic cylinder.

18. A material handling vehicle, comprising:
a mast coupled to a body and slidably engaged with a set of forks, a hydraulic cylinder of the material handling vehicle being configured to raise and lower the set of forks along the mast;
a height sensor configured to determine a height of a portion of the set of forks with respect to a threshold height on the mast;
a light assembly coupled to the body, the light assembly including an upper light portion, a lower light portion, and a side light portion;
an operator presence system configured to detect a presence of an operator;
a pedestrian detection system configured to detect a presence of a pedestrian; and
a controller coupled to the height sensor, the light assembly, the operator presence system, and the pedestrian detection system,
wherein the controller is configured to:
send a first signal to the light assembly to illuminate the upper light portion at a first intensity and the lower light portion at a second intensity when the height of the portion of the set of forks is above the threshold height,
send a second signal to illuminate the lower light portion at the first intensity and not illuminate the upper light portion when the height of the portion of the set of forks is below the threshold height, and
send a third signal to illuminate the side light portion when one or more of the presence of the operator presence system is active or the presence of a pedestrian is detected.

19. The material handling vehicle of claim 18, wherein the operator presence system includes one or more of a seat switch or a seatbelt interlock, and the operator presence system is active when the seat switch is not actuated or when the seatbelt interlock is active.

20. The material handling vehicle of claim 19, wherein the seatbelt interlock is active when a seatbelt of the material handling vehicle is not buckled.
